(19) United States
(12) Patent Application Publication
(10) Pub. No.: US 2014/0104176 A1
(43) Pub. Date: Apr. 17, 2014

(54) Ultra-Compact Keyboard

(71) Applicant: INTERNATIONAL BUSINESS MACHINES CORPORATION, Armonk, NY (US)

(72) Inventor: William G. Pagan, Durham, NC (US)

(73) Assignee: International Business Machines Corporation, Armonk, NY (US)

(21) Appl. No.: 13/734,492

(22) Filed: Jan. 4, 2013

Related U.S. Application Data
(63) Continuation of application No. 13/654,083, filed on Oct. 17, 2012.

(51) Int. Cl. G06F 3/02

(52) U.S. Cl. CPC G06F 3/02
USPC 345/168

(57) ABSTRACT

An embodiment of the invention provides a method of character recognition where input is received from an actuated key. The angle of the input is determined with a sensor, wherein the angle of the input includes pressure on a first axis, pressure on a second axis, and/or pressure on an additional axis. A processor matches the angle of the input to an identified character in a memory device, wherein the memory device includes a plurality of characters, each of the characters corresponding to a key and an angle of input. The identified character is displayed on a display.

This patent application is a continuation application of U.S. patent application Ser. No. 13/654,083 filed on Oct. 17, 2012, which is hereby incorporated by reference.

### BACKGROUND

The present invention is in the field of methods, systems, devices, and computer program products for an ultra-compact keyboard.

With the advent of smaller, more powerful microprocessors, small form devices such as cellular telephones and tablet computers are used every day for complex tasks that often require a full keyboard to interact with. This has resulted in the miniaturization of both physical keyboards (e.g., smart phones) and virtual keyboards (e.g., touchscreen interfaces). The smaller keyboards are typically accessed with only one finger on each hand (e.g., thumb or index).

### SUMMARY OF THE INVENTION

An embodiment of the invention provides a method of character recognition where input is received from an actuated key. The angle of the input is determined with a sensor, wherein the angle of the input includes pressure on a first axis, pressure on a second axis, and/or pressure on an additional axis. A processor matches the angle of the input to an identified character in a memory device, wherein the memory device includes a plurality of characters, each of the characters corresponding to a key and an angle of input. The identified character is displayed on a display.

Another embodiment of the invention provides a method of character recognition where input is received from an actuated key. The contacted region of the actuated key is determined with a sensor, wherein the contacted region includes a first region on the actuated key, a second region on the actuated key, and/or an additional region on the actuated key. A processor matches the contacted region of the actuated key to an identified character in a memory device, the memory device including a plurality of characters, each of the characters corresponding to a key and a region on the key. The identified character is displayed on a display.

Yet another embodiment of the invention provides a method of character recognition where input is received from an actuated key. A sensor determines the angle of the input and/or the contacted region of the actuated key. The angle of the input includes pressure on a first axis, pressure on a second axis, and/or pressure on an additional axis. The contacted region of the actuated key includes a first region on the actuated key, a second region on the actuated key, and/or an additional region on the actuated key. A processor selects an identified character based on a signal from the sensor; and, the identified character is displayed on a display.

### BRIEF DESCRIPTION OF THE SEVERAL VIEWS OF THE DRAWINGS

The present invention is described with reference to the accompanying drawings. In the drawings, like reference numbers indicate identical or functionally similar elements.

FIG. 1 illustrates a key according to an embodiment of the invention;

FIG. 2 is a flow diagram illustrating a method of character recognition according to an embodiment of the invention;

FIG. 3 is a flow diagram illustrating a method of character recognition according to another embodiment of the invention;

FIG. 4 illustrates the actuated key according to an embodiment of the invention;

FIG. 5 illustrates the actuated key according to another embodiment of the invention;

FIG. 6 illustrates a character input device according to an embodiment of the invention;

FIG. 7 illustrates a character input device according to another embodiment of the invention; and

FIG. 8 illustrates a computer program product according to an embodiment of the invention.

### DETAILED DESCRIPTION

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

At least one embodiment of the invention provides a keyboard with one or more rows of keys that can detect the portion or angle of the key struck. Thus, a smaller functional keyboard can be provided. In an ultra-compact keyboard according to an embodiment of the invention, one or more physical or virtual (e.g., touchscreen display) keys on the keyboard can be used to enter two or more characters, depending on the angle of pressure exerted upon the key.

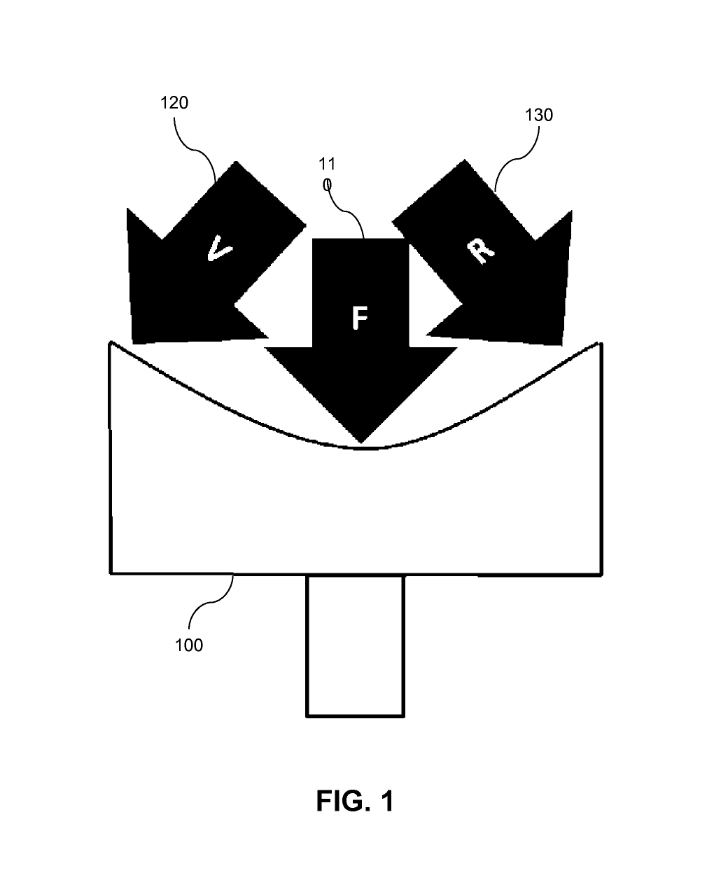

FIG. 1 illustrates a pressure sensitive key 100 that detects the angle of pressure on the key to determine which character is typed according to an embodiment of the invention. Pressure on a first downward axis (also referred to herein as a “first axis”, “downward axis”, “first direction”, or “downward direction”) 110 of the key 100 produces a first character (e.g., the character “F”). Pressure on a second axis (also referred to herein as a “second direction”) 120 of the key 100 produces a second character (e.g., the character “V”). In at least one embodiment, the axis 120 is at a tilt relative to the downward axis 100 as viewed on a vertical plane (e.g., 35 to 55 degrees). Pressure on a third axis (also referred to herein as a “third direction”) 130 of the key 100 produces a third character (e.g., the character “R”). In at least one embodiment, the axis 130 is at a tilt relative to the downward axis 100 as viewed on a vertical plane (e.g., −35 to −55 degrees).

The key can be enabled by combining a physical key with a trackpoint-like connecting apparatus. To enhance the differentiation between character strokes, the physical key can have a concave shape that allows for more leverage to be exerted against the pressure-sensitive sensor when the typist presses against the top and bottom of the key. In at least one embodiment, the key is depressed as typical, but the angle of the pressure exerted, in combination with the keypress, is what determines which character has been selected. By implementing keys in this fashion, three rows of keys may be combined into a single row of keys, thereby enabling a fully function keyboard in a much smaller overall footprint.

In at least one embodiment of the invention, optical or touch sensors can be positioned at the top, middle, and bottom of a key to detect the portion of the key that has been depressed. Upon keypress, the sensors that are contacted are determined. If all three sensors are contacted, the middle key can be selected. If the top sensor is not contacted but the bottom two sensors are contacted, then the bottom character is selected.

In another embodiment of the invention, an optical sensor in or proximate to the key identifies the location of user's finger. Specifically, the location of the user's finger relative to one or more regions of the key (e.g., the center of the key) is identified in order to determine which function to actuate. Another embodiment identifies the user's fingerprint on the key and aligns selected points of the fingerprint with points on the key to determine the region of the key that was struck. In yet another embodiment, various piezoelectric sensors are positioned in the key cap to detect the region(s) on the key surface that was struck. This can take advantage of key shape to isolate compression and vibration to the other sensors on-board the same key.

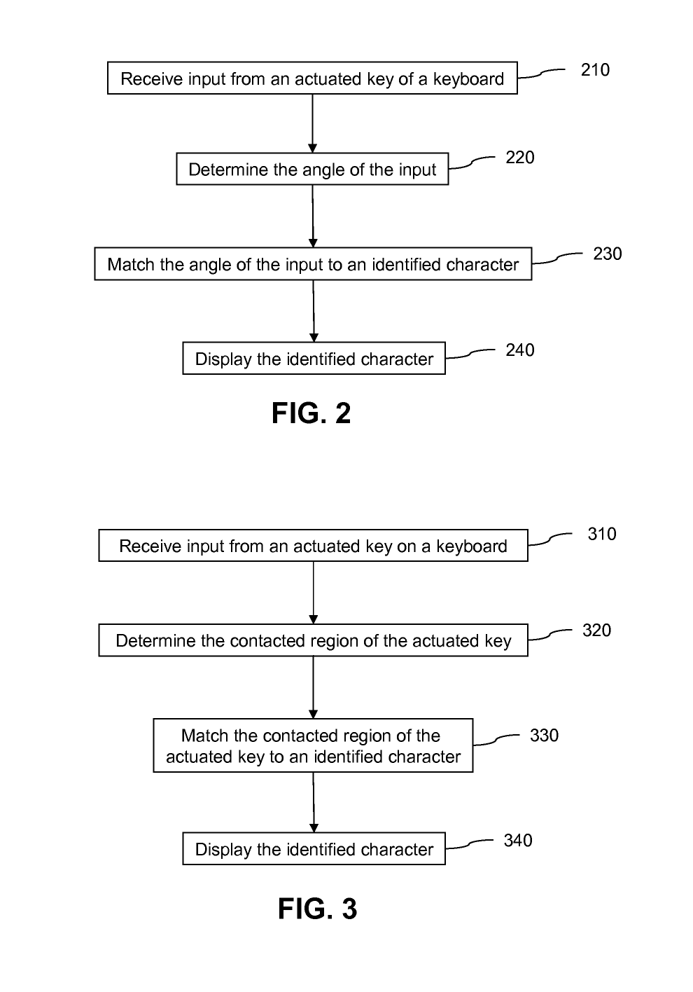

FIG. 2 is a flow diagram illustrating a method of character recognition according to an embodiment of the invention. As used herein, the term “character” includes letters, numbers, punctuation, and symbols. Input is received from an actuated (e.g., depressed) key of a keyboard 210. As used herein, the term “keyboard” as used herein includes physical keyboards, such as keyboards connected to a desktop computer or on a laptop computer, keypads, such as those connected to a telephone, and virtual keyboards, such as those on the touchscreen monitors of some tablet computers and smartphones.

The angle of the input is determined with a sensor 220. In at least one embodiment, the sensor is a hardware device connected to the key for determining the angle of input. As used herein, the term “sensor” includes pressure-sensitive sensors (piezoelectric sensors) and/or optical sensors. As used herein, the term “connected” includes operationally connected, logically connected, in communication with, physically connected, engaged, coupled, contacts, linked, affixed, and attached.

In at least one embodiment of the invention, the angle of the input includes pressure on a first axis, pressure on a second axis, and/or pressure on at least one additional axis (also referred to herein as the “third axis”). The first axis is perpendicular to the top surface of the actuated key and/or the top surface of the keyboard housing the actuated key. The second axis is between the first axis and an axis that is parallel to the top surface of the actuated key and/or the top surface of a keyboard housing the actuated key. The first axis is between the second axis and the additional axis. In the example illustrated in FIG. 1, pressure on the first axis produces the character “F”, pressure on the second axis produces the character “V”, and pressure on the additional axis produces the character “R”. When the input includes pressure on the first axis and pressure on the second axis and/or pressure on the additional axis, the sensor determines that the first axis is the angle of the input.

A processor selects an identified character based on a signal from the sensor. More specifically, the processor matches the angle of the input to an identified character in a memory device 230. In at least one embodiment, the processor is a hardware device connected to the sensor and the memory device. The memory device is a hardware storage device (e.g., RAM) that includes a plurality of characters, where each of the characters corresponds to a key on the keyboard and an angle of input. The processor is further connected to a display (e.g., touchscreen device, computer monitor, cell phone screen, e-reader screen), which displays the identified character 240.

For example, if a first key is actuated along the second axis, then the processor queries the memory device and matches this input to the character “B”. In another example, if a sixth key is actuated along the third axis, then the processor queries the memory device and matches this input to the character “R”. In yet another example, if a twentieth key is actuated along the first axis, then the processor queries the memory device and matches this input to the comma punctuation character “,”.

FIG. 3 is a flow diagram illustrating a method of character recognition according to another embodiment of the invention, wherein input is received from an actuated key on a keyboard 310. In at least one embodiment, the key is actuated via contact of the key with a finger or stylus. The contacted region of the actuated key is determined with a sensor 320, wherein the contacted region includes a first region on the actuated key, a second region on the actuated key, and/or at least one additional region on the actuated key (also referred to herein as the “third region”).

FIG. 4 illustrates the actuated key according to an embodiment of the invention, wherein the first region 410 is in the center of the actuated key, the second region 420 is in the section of the actuated key relative to the user, and the third region 430 is in the right section of the actuated key relative to the user. In another embodiment, the second region is in the right section of the actuated key, and the third region is in the left section of the actuated key. In yet another embodiment, the first region is in the left section of the actuated key or the right section of the actuated key; and, either the second region or the third region is in the center section of the actuated key.

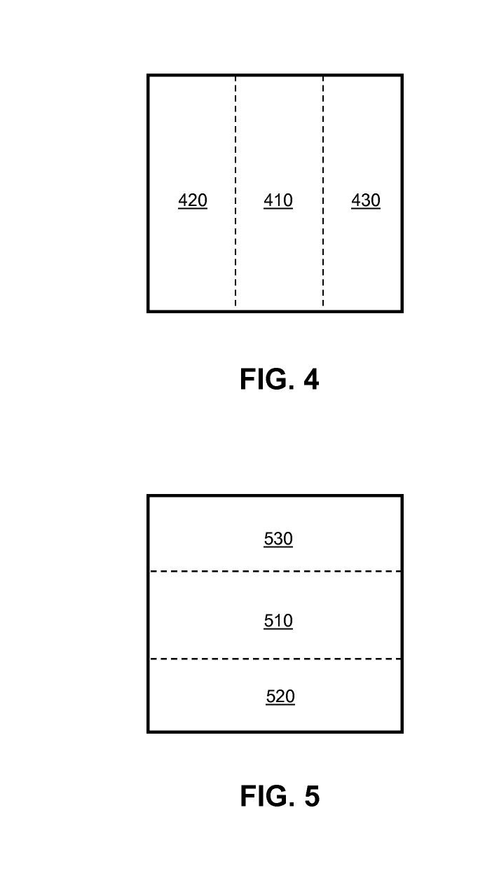

FIG. 5 illustrates the actuated key according to another embodiment of the invention, wherein the first region 510 is in the center of the actuated key, the second region 520 is in the front section of the actuated key relative to the user, and the third region 530 is in the rear section of the actuated key relative to the user. In another embodiment, the second region is in the rear section of the actuated key, and the third region is in the front section of the actuated key. In yet another embodiment, the first region is in the front section of the actuated key or the rear section of the actuated key; and, either the second region or the third region is in the center section of the actuated key.

The processor selects an identified character based on a signal from the sensor. More specifically, referring back to FIG. 3, the processor matches the contacted region of the actuated key to an identified character in a memory device 330. The memory device includes a plurality of characters, wherein each of the characters corresponds to a key and a region on the key. The identified character is displayed on a display 340.

For example, if a first key is actuated along the second region, then the processor queries the memory device and matches this input to the character “B”. In another example, if a sixth key is actuated along the third region, then the processor queries the memory device and matches this input to the character “R”. In yet another example, if a twentieth key is actuated along the first region, then the processor queries the memory device and matches this input to the comma punctuation character “,”. In at least one embodiment, when the input includes contact on the first region and contact on the second region and/or contact on the third region, then the processor determines that the first region is the contacted region.

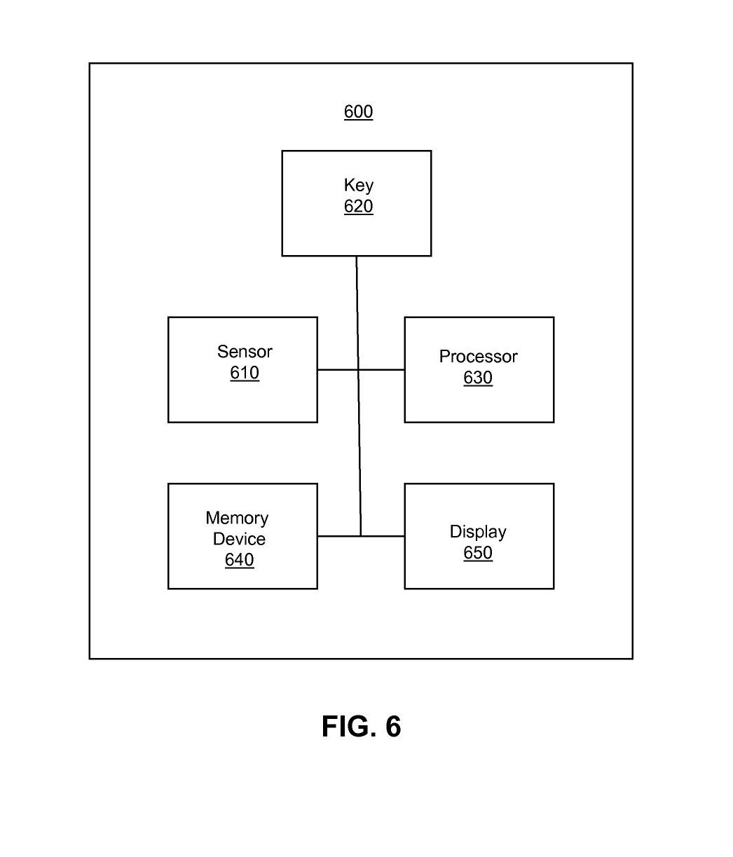

FIG. 6 illustrates a device for character recognition (also referred to herein as the “character input device” or “device”) 600 according to an embodiment of the invention, wherein the device 600 includes a sensor 610 proximate a key 620. As used herein, “proximate” is intended to mean near, adjacent, contiguous, next to, close to, by, on, in contact with, and the like. The sensor 610 identifies the angle in which pressure is applied to the key by a user (also referred to herein as the “angle of key actuation”), wherein the angle of key actuation can be on a first axis, a second axis, and/or an additional axis (also referred to herein as the “third axis”).

In at least one embodiment, the first axis is perpendicular to the top surface of the key 620 and/or the top surface of the keyboard housing the key 620. For instance, as shown in the example illustrated in FIG. 1, the first axis 110 is perpendicular to the top surface of the key 100. In another embodiment, the first axis is not perpendicular to the top surface of the key 620 and not perpendicular to the top surface of the keyboard. The second axis can be between the first axis and an axis that is parallel to the top surface of the key 620, bottom surface of the key 620, top surface of the keyboard, and/or bottom surface of the keyboard. For instance, as shown in the example illustrated in FIG. 1, the second axis 120 is between the first axis 110 and an axis that is parallel to the top surface of the key 620, i.e., an imaginary line from the top left corner of the key 100 to the top right corner of the key 100 (from a front perspective of the key 100). Furthermore, the first axis can be between the second axis and the additional axis. As shown in the example illustrated in FIG. 1, the first axis 110 is between the second axis 120 and the third axis 130.

A processor 630 is connected to the sensor 610, where the processor 630 selects an identified character from a memory device 640 based on a signal from the sensor 610. More specifically, the processor 630 matches an identified character in the memory device 640 to the angle of key actuation. The angle of key actuation can include pressure on the first axis, pressure on the second axis, and/or pressure on the additional axis. The memory device 640 includes a plurality of characters, wherein each of the characters correspond to a key on the keyboard and an angle of key actuation of the key on the keyboard. For instance, as shown in the example illustrated in FIG. 1, the processor 630 can match input along the first axis 110 to the letter “F”, input along the second axis 120 to the letter “V”, and input along the third axis 130 to the letter “R”. In at least one embodiment, the processor 630 identifies the first axis as the angle of key actuation when input from the user via the key 620 includes pressure on the first axis and pressure on the second axis and/or pressure on the additional axis. Thus, in the example above, the processor 630 selects the letter “F” when input includes pressure along the first axis 110 and the second axis 120. A display 650 is connected to the processor 630, wherein the display 650 displays the identified character. In at least one embodiment, the display 650 is a touchscreen monitor on a tablet computer.

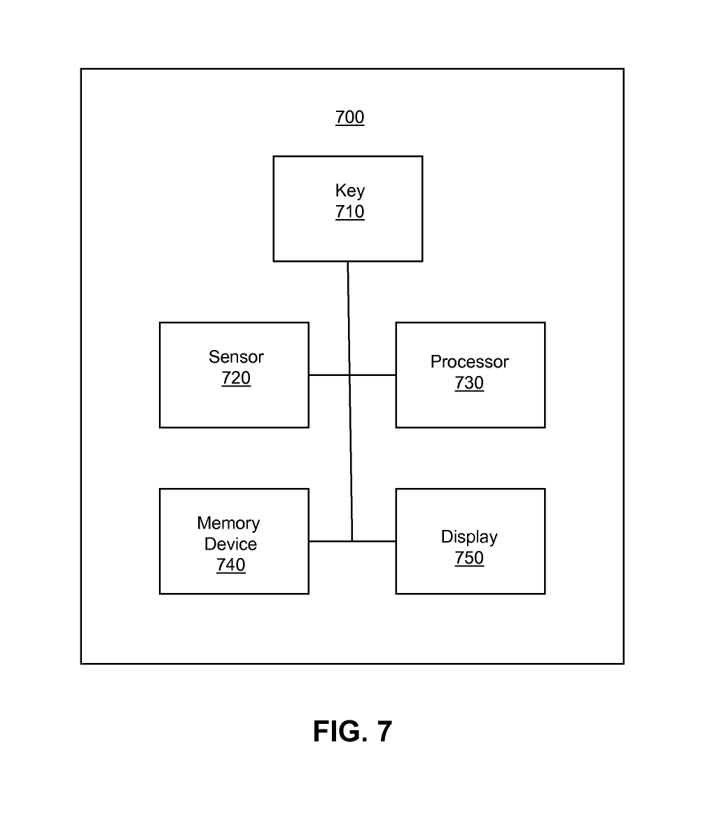

FIG. 7 illustrates a character input device 700 having a key 710, a sensor 720, a processor 730, a memory device 740, and a display 750 according to an embodiment of the invention. The key 710 includes a first region, a second region, and at least one additional region (also referred to herein as the “third region”).

In at least one embodiment, as shown in the example illustrated in FIG. 4, the first region 410 is in the center of the key, the second region 420 is in the left section of the key, and the third region 430 is in the right section of the key. In another embodiment, the second region is in the right section of the key, and the third region is in the left section of the key. In yet another embodiment, the first region is in the left section of the key. In this embodiment, the second region is in the middle section of the key and the third region is in the right section of the key, or vice versa. In still yet another embodiment, the first region is in the right section of the key. In this embodiment, the second region is in the middle section of the key and the third region is in the left section of the key, or vice versa.

In another embodiment of the invention, as shown in the example illustrated in FIG. 5, the first region 510 is in the center of the key, the second region 520 is in the front section of the key, and the third region 530 is in the rear section of the key. In another embodiment, the second region is in the rear section of the key, and the third region is in the front section of the key. In yet another embodiment, the first region is in the front section of the key. In this embodiment, the second region is in the middle section of the key and the third region is in the rear section of the key, or vice versa. In still yet another embodiment, the first region is in the rear section of the key. In this embodiment, the second region is in the middle section of the key and the third region is in the front section of the key, or vice versa. In still yet another embodiment, the key 710 includes more than three regions.

The sensor 720 is proximate to the key 710, where the sensor 720 identifies the region of the key 710 that is contacted by the user (also referred to herein as the “contacted region of the key”). The contacted region can be the first region, the second region, and/or the third region. When input via the key 710 includes contact on the first region and contact on the second region and/or contact on the third region, the sensor 720 identifies the first region as the contacted region. For instance, in the example illustrated in FIG. 4, the sensor 720 identifies the contacted region as the first region 410 when both the first region 410 and second region 420 are contacted by the user simultaneously. In the example illustrated in FIG. 5, the sensor 720 identifies the contacted region as the first region 510 when both the first region 510 and third region 520 are contacted by the user simultaneously.

The processor 730 is connected to the sensor 720, where the processor 730 selects an identified character from the memory device 740 based on a signal from the sensor 720. More specifically, the processor 730 matches an identified character in the memory device 740 to the contacted region of the key 710. In at least one embodiment, the memory device includes a plurality of characters, wherein each of the characters correspond to a key on the keyboard and a region on the key on the keyboard. The display 750 is connected to the processor 730, where the display 750 displays the identified character. In at least one embodiment, the display 750 is a screen on a mobile telephone.

As will be appreciated by one skilled in the art, aspects of the present invention may be embodied as a system, method or computer program product. Accordingly, aspects of the present invention may take the form of an entirely hardware embodiment or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

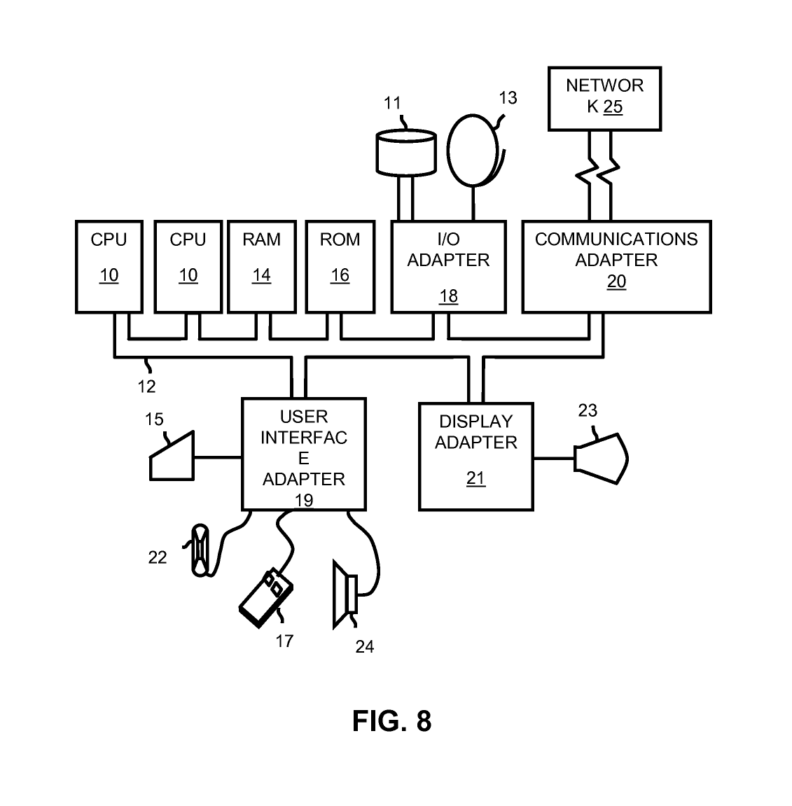

Referring now to FIG. 8, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected with system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of at least one other feature, integer, step, operation, element, component, and/or groups thereof.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A device comprising:
a key including a first region, a second region, and at least one additional region;
a sensor proximate said key, said sensor identifies at least one of:
a contacted region of said key, said contacted region including at least one of the first region, the second region, and the at least one additional region, and
an angle of key actuation, said angle of key actuation including at least one of pressure on a first axis, pressure on a second axis, and pressure on at least one additional axis;
a processor connected to said sensor, said processor matches an identified character in a memory device to at least one of the contacted region of said key and the angle of key actuation; and
a display connected to said processor, said display displays the identified character.

2. The device according to claim 1, wherein said memory device includes a plurality of characters, each of the characters corresponding to a key on a keyboard and at least one of an angle of key actuation of the key on the keyboard and a region on the key on the keyboard.

3. The device according to claim 1, wherein said sensor identifies the first axis as the angle of key actuation when input via said key includes pressure on the first axis and at least one of pressure on the second axis and pressure on the additional axis.

4. The device according to claim 1, wherein the first axis is perpendicular to at least one of a top surface of said key and a top surface of a keyboard housing said key,
the second axis is between the first axis and an axis that is parallel to at least one of the top surface of said key and the top surface of said keyboard, and
the first axis is between the second axis and the additional axis.

5. The device according to claim 1, wherein said sensor identifies the first region as the contacted region when input via said key includes contact on the first region and at least one of contact on the second region and contact on the additional region.

6. The device according to claim 1, wherein the first region is in a center of said key.

7. The device according to claim 1, wherein the first region is in one of a front section of said key and a rear section of said key.

8. The device according to claim 1, wherein the second region is in one of a front section of said key and a rear section of said key,
the additional region is in one of the front section of said key and the rear section of said key, and
the first region is between the additional region the second region.

9. The device according to claim 1, wherein the second region is in one of a left section of said key and a right section of said key,
wherein the additional region is in one of the left section of said key and the right section of said key, and
wherein the first region is between the additional region the second region.

10. The device according to claim 1, wherein said key includes a concave top surface.

11. A character input device comprising:
a sensor proximate a key, said sensor identifies an angle of key actuation, said angle of key actuation including at least one of a first axis, a second axis, and at least one additional axis;
a processor connected to said sensor, said processor matches an identified character in a memory device to the angle of key actuation; and
a display connected to said processor, said display displays the identified character.

12. The character input device according to claim 11, wherein said processor identifies the first axis as the angle of key actuation when input via said key includes pressure on the first axis and at least one of pressure on the second axis and pressure on the additional axis.

13. The character input device according to claim 11, wherein the first axis is perpendicular to at least one of a top surface of said key and a top surface of a keyboard housing said key.

14. The character input device according to claim 13, wherein the second axis is between the first axis and an axis that is parallel to at least one of the top surface of said key and the top surface of said keyboard.

15. The character input device according to claim 14, wherein the first axis is between the second axis and the additional axis.

16. A character input device comprising:
a key including a first region, a second region, and at least one additional region;
a sensor proximate said key, said sensor identifies a contacted region of said key, said contacted region including at least one of the first region, the second region, and the at least one additional region;
a processor connected to said sensor, said processor matches an identified character in a memory device to the contacted region of said key; and
a display connected to said processor, said display displays the identified character.

17. The character input device according to claim 16, wherein said sensor identifies the first region as the contacted region when input via said key includes contact on the first region and at least one of contact on the second region and contact on the additional region.

18. The character input device according to claim 16, wherein the first region is in a center of said key.

19. The character input device according to claim 16, wherein the first region is in one of a front section of said key and a rear section of said key.

20. The character input device according to claim 16, wherein the second region is in one of a front section of said key and a rear section of said key.

21. The character input device according to claim 20, wherein the additional region is in one of the front section of said key and the rear section of said key, and the first region is between the additional region the second region.

22. The character input device according to claim 16, wherein the second region is in one of a left section of said key and a right section of said key.

23. The character input device according to claim 22, wherein the additional region is in one of the left section of said key and the right section of said key, and
the first region is between the additional region the second region.

24. A device comprising:
a key including a first region, a second region, and at least one additional region;
a sensor proximate said key, said sensor identifies at least one of:
a contacted region of said key, said contacted region including at least one of the first region, the second region, and the at least one additional region, and
an angle of key actuation, said angle of key actuation including at least one of a first axis, a second axis, and at least one additional axis;
a processor connected to said sensor, said processor selects an identified character from a memory device based on a signal from said sensor; and
a display connected to said processor, said display displays the identified character.

25. The device according to claim 24, wherein said memory device includes a plurality of characters, each of the characters corresponding to a key on a keyboard and an angle of key actuation of the key on the keyboard.
